(19) United States
(12) Patent Application Publication
(10) Pub. No.: US 2008/0178623 A1
(43) Pub. Date: Jul. 31, 2008

(54) Beverage cooler

(76) Inventor: Richard S. Cunningham, North Lauderdale, FL (US)

Correspondence Address: Stephen R. Greiner, Esquire;GREINER LAW OFFICES, P.C., 6701 Democracy Blvd., Suite 110, Bethesda, MD, 20817, US

(21) Appl. No.: 12/007,173

(22) Filed: Jan. 8, 2008

Related U.S. Application Data
(60) Provisional application No. 60/898,183, filed on Jan. 30, 2007.

(51) Int. Cl. B60N 3/10; B60H 1/32; F25D 31/00

(52) U.S. Cl. 62/244; 224/483; 248/311.2

(57) ABSTRACT

A beverage cooler for use in a land vehicle. The beverage cooler includes a housing having an inlet for receiving air from a register in the land vehicle and having an outlet in fluid communication with the inlet for discharging air into the passenger compartment of the land vehicle carrying the register. A mounting bracket is connected to the housing for securing the housing to the register of a land vehicle. An insert is removably positioned within the housing. The insert includes a tubular sleeve for releasably holding a beverage container. The sleeve has a circular bottom wall and a cylindrical side wall that is affixed to, and extends upwardly from, the bottom wall. A peripheral collar extends outwardly from the top of the sleeve so as to engage the top of the housing. An absorbent pad is positioned the bottom of the tubular sleeve atop the bottom wall. A wicking strip contacts the absorbent pad and conveys, via capillary action, water away from the absorbent pad. The wicking strip is also secured within a slot in the side wall of the sleeve.

### PRIORITY INFORMATION

For priority purposes, this application claims the benefit of Provisional Application for Patent, Ser. No. 60/898,183, filed on Jan. 30, 2007.

### FIELD OF THE INVENTION

The present invention relates generally to supports and, more particularly, to brackets having receptacle-type, article holding means.

### BACKGROUND OF THE INVENTION

Many occupants of automobiles and trucks enjoy eating and drinking while driving about. Unfortunately, refrigerated beverages, especially soft drinks packed in aluminum cans, have a tendency to become warm over time, making them less pleasant to drink. To solve the problem, some have proposed insulated cups to retain beverages at low temperatures for long periods of time. These things, however, are often bulky and heavy and are difficult to fit into cup holders commonly found in land vehicles. So, a user must hold onto the cup for the duration of his trip, or until the beverage is consumed, to prevent spilling.

To overcome some of the problems associated with insulated cups, others have proposed devices that suspend a beverage container within the flow of chilled air from the air conditioning system of a land vehicle. These devices have been complex in terms of their construction, however, and have not seen widespread use. The devices have been further limited in terms of their utility by an inability to reduce the temperature of a beverage below that of the air emitted by the air conditioning system with which it is used.

### SUMMARY OF THE INVENTION

In light of the problems associated with the known efforts associated with maintaining a beverage in a chilled state while traveling in a land vehicle, it is a principal object of the invention to provide a beverage cooler that, in a practical manner, suspends a beverage container, such as an aluminum can, in the flow of chilled air from the air conditioning system of a land vehicle so as to reduce the temperature of the contained beverage to a point below that of the chilled air by evaporating water from elements in contact with the exterior of the beverage container.

It is an object of the invention to provide improved features and arrangements thereof in a beverage cooler for the purposes described which is lightweight in construction, inexpensive to manufacture, and dependable in use.

Briefly, the beverage cooler in accordance with this invention achieves the intended objects by featuring a housing having an air inlet and an air outlet. A mounting bracket is connected to the housing for securing the housing to the register of a land vehicle to receive chilled air therefrom. An insert is removably positioned within the housing for releasably holding a beverage container. An absorbent pad, capable of being selectively saturated with water, is positioned in the bottom of the insert. A wicking strip contacts the absorbent pad and conveys, via capillary action, water away from the absorbent pad where such can evaporate in air flowing through the housing to cool the beverage container held therein.

The foregoing and other objects, features, and advantages of the present invention will become readily apparent upon further review of the following detailed description of the preferred embodiment as illustrated in the accompanying drawings.

### BRIEF DESCRIPTION OF THE DRAWINGS

The present invention may be more readily described with reference to the accompanying drawings, in which:

FIG. 1 is an environmental perspective view of a beverage cooler in accordance with the present invention shown mounted upon an air register in the passenger compartment of a land vehicle.

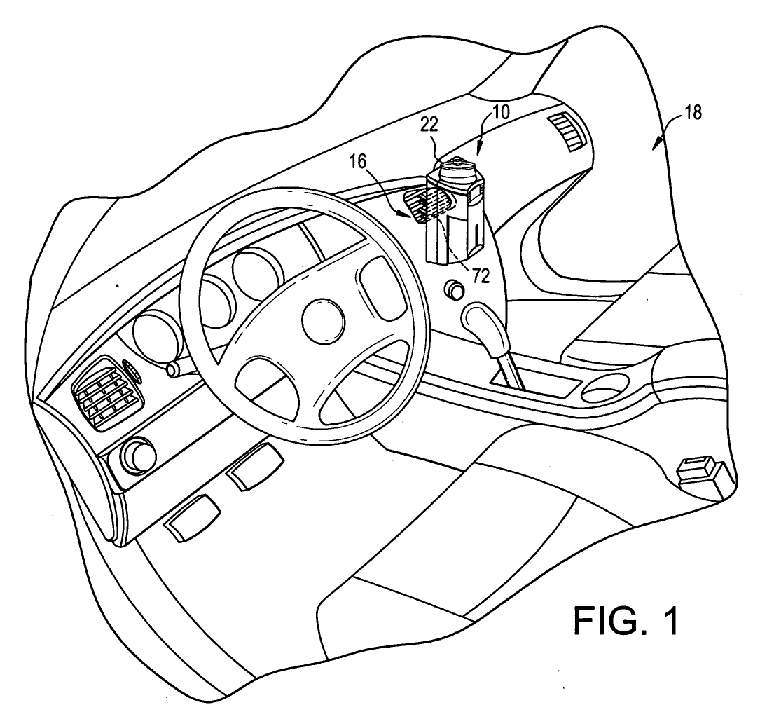

FIG. 2 is a perspective view of the beverage cooler of FIG. 1.

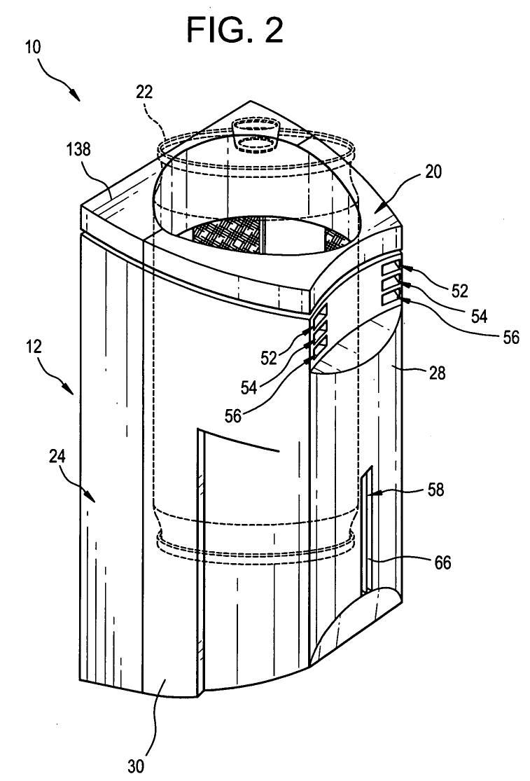

FIG. 3 is a perspective view of the removable insert of the beverage cooler.

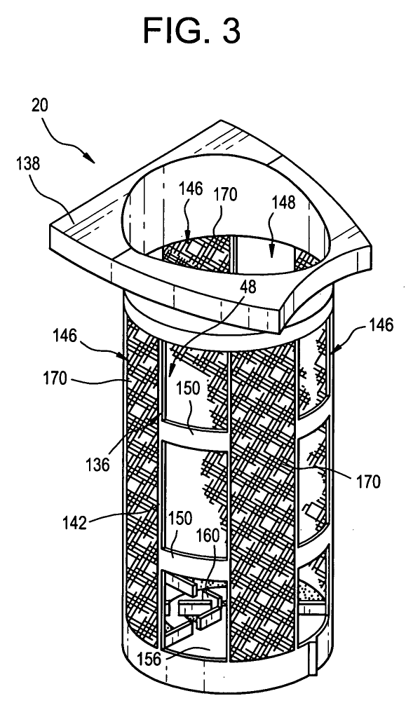

FIG. 4 is a rear elevational view of the beverage cooler.

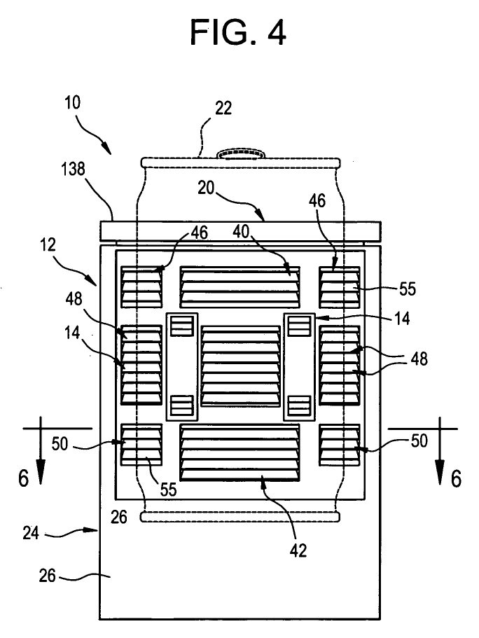

FIG. 5 is an exploded, side elevational view of the beverage cooler having portions broken-away so as to reveal the internal details thereof.

FIG. 6 is a cross-sectional view taken along line 6-6 of FIG. 4.

FIG. 7 is a perspective view of the beverage cooler with the front portion thereof broken away so as to reveal internal details of the cooler.

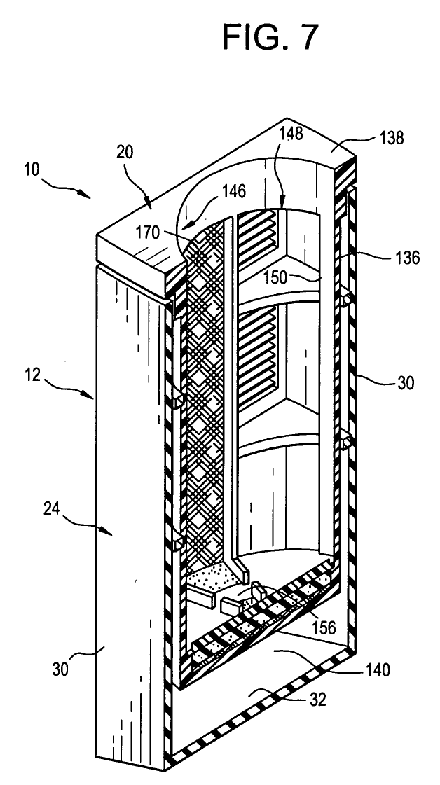

FIG. 8 is a perspective view of a mounting bracket of the beverage cooler.

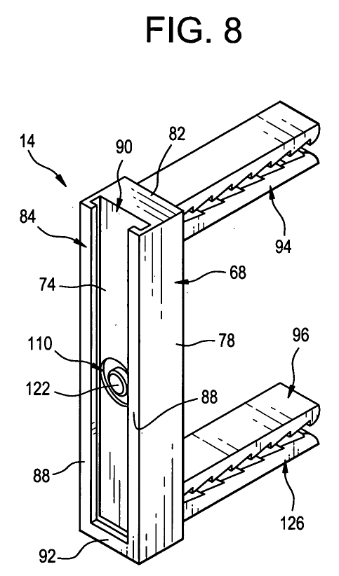

Similar reference characters denote corresponding features consistently throughout the accompanying drawings.

### DETAILED DESCRIPTION

Referring now to the FIGS., a beverage cooler in accordance with the present invention is shown at 10. Beverage cooler 10 includes a housing 12 supported by means of a pair of mounting brackets 14 adjacent a register 16 provided for the controlled admission of air into the passenger compartment 18 of a land vehicle. An insert 20 is removably positioned within housing 12 to hold a beverage container 22. Insert 20 contains a quantity of water that is evaporated in the flow of air from register 16 and through housing 12 to cool container 22.

Housing 12 comprises a ventilated box 24 that is adapted to receive insert 20. Box 24 has a planar, back wall 26 for abutment with register 16. A front wall 28 is connected in opposition to back wall 26 by a pair of side walls 30 that project rearwardly from front wall 28. A bottom wall 32 closes the bottom of box 24 and is connected to back wall 26, front wall 28, and side walls 30. The top of box 24 is open to receive insert 20.

A pair of mounting rails 34 is affixed to back wall 26. Each of rails 34 has a T-shaped cross section with a narrow stem 36 projecting rearwardly from back wall 26. At the free end of each stem 36 is affixed a relatively wide crosspiece 38. Rails 34 are set in laterally spaced positions on opposite sides of back wall 26.

Back wall 26 is provided at its center with three primary air inlets 40, 42, and 44. Inlet 40 is located near the top of back wall 26. Inlet 42, however, is located proximate the bottom of back wall 26. Additionally, inlet 44 is positioned between inlets 40 and 42 and between rails 34.

Inlets 40, 42 and 44 are respectively flanked by pairs of secondary inlets 46, 48, and 50. One of inlets 46 is located on each of the opposite sides of inlet 40. Also, one of inlets 48 is located on each of the opposite sides of inlet 44, outside of rails 34. Further, one of inlets 50 is located on each of the opposite sides of inlet 42. Taken together with inlets 40-44, inlets 46-50 permit a substantial flow of air from register 16 into housing 12. Slats 55 fitted within inlets 40-50 direct the flow of air into housing 12.

The top of front wall 28 is provided with three pairs of air outlets 52, 54, and 56. As shown, air outlets 52 are positioned side-by-side in front wall 28. Positioned below outlets 52 are air outlets 54. Below outlets 54 are air outlets 56. Outlets 52, 54, and 56 permit air entering housing 12 through inlets 40-50 to exit housing 12 at the top thereof.

The bottom of front wall 28 is provided with an air outlet 58 for passing from housing 12 air received through inlets 40-50. Air outlet 58 is bounded at its top by a horizontal, top outlet surface 60 and is bounded at its bottom by a forwardly and downwardly sloping, bottom outlet surface 62 that serve to direct air downward. Air outlet 58 is further bounded at its sides by vertical, yet inwardly angled, side outlet surfaces 64 that serve to concentrate and direct the flow of air received from opposite sides of housing 12 into a forwardly moving stream. The resulting flow from outlet 58 is forward and downward.

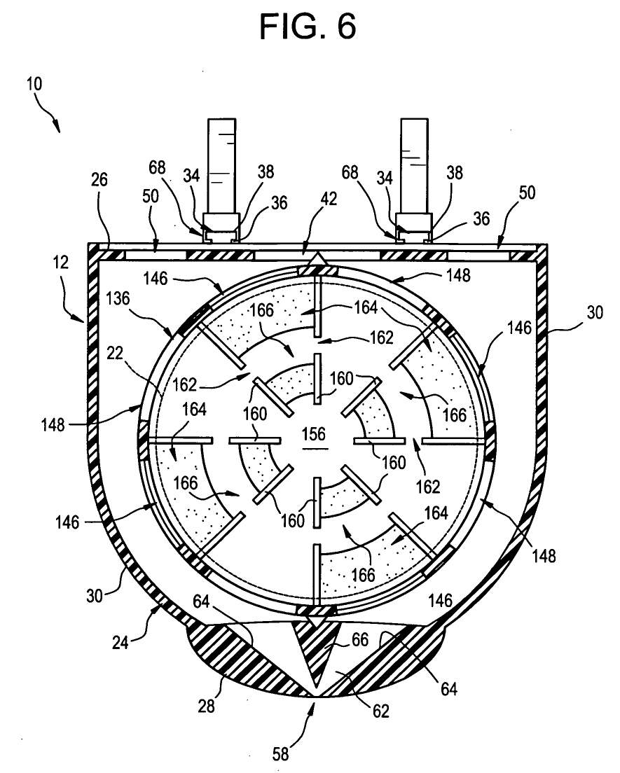

A flow channeling fin 66 is affixed in the center of air outlet 58 to ensure that air flows smoothly through outlet 58. Fin 66 extends from top outlet surface 60 to bottom outlet surface 62 and is positioned midway between surfaces 64 so as to divide the air flow within outlet 58. Fin 66 is triangular in cross section, as is best seen in FIG. 6, and tapers in width to a narrow forward edge at the front of outlet 58 to inhibit turbulence. Fin 66 is integrally formed with front wall 28.

A pair of mounting brackets 14 is releasably joined to mounting rails 34 so as to project rearwardly from housing 12. Each of mounting brackets 14 includes a base block 68 for engagement with a respective one of rails 34 and a resilient clip 70 that partially extends from block 68 to grasp a pair of horizontally oriented flow diverters 72 within register 16. Block 68 and clip 70 are made from durable plastic or other suitable material.

Base block 68 is rectangular in form and hollow. As such, block 68 has a front panel 74 and a back panel 76 connected together by a pair of opposed side panels 78. A bottom panel 80 closes the bottom of block 68 and a top panel 82 caps the top of block 68.

A pair of L-shaped retaining flanges 84 extends forwardly from front panel 74. Each of flanges 84 has a forwardly extending branch 86 that is affixed along a respective side of front panel 74. Each of flanges 84 also has an inwardly facing limb 88 that is affixed to the free end of a branch 86. Together, flanges 84 define an internal channel 90 that snugly, yet slidably, receives a respective one of rails 34. To ensure that rails 34 do not become detached from flanges 84 during the use of cooler 10, a stop 92 projects outwardly from the bottom of each block 68 between flanges 84 that is sufficiently large so as to catch upon a rail 34 and prevent the continued movement of the rail 34 through channel 90.

A pair of fixed jaws 94 and 96 is affixed to back panel 76. Jaw 94 has a bar 98 that is affixed at its front end to the top of back panel 76 and extends rearwardly therefrom. Jaw 96, however, has a bar 100 that is affixed at its front end to the bottom of back panel 76 and extends rearwardly therefrom. The top of bar 98 is provided with a series of laterally spaced teeth 102 for gripping a flow diverter 72 of register 16. Similarly, the bottom of bar 100 is provided with a series of laterally spaced teeth 104 for gripping another flow diverter 72.

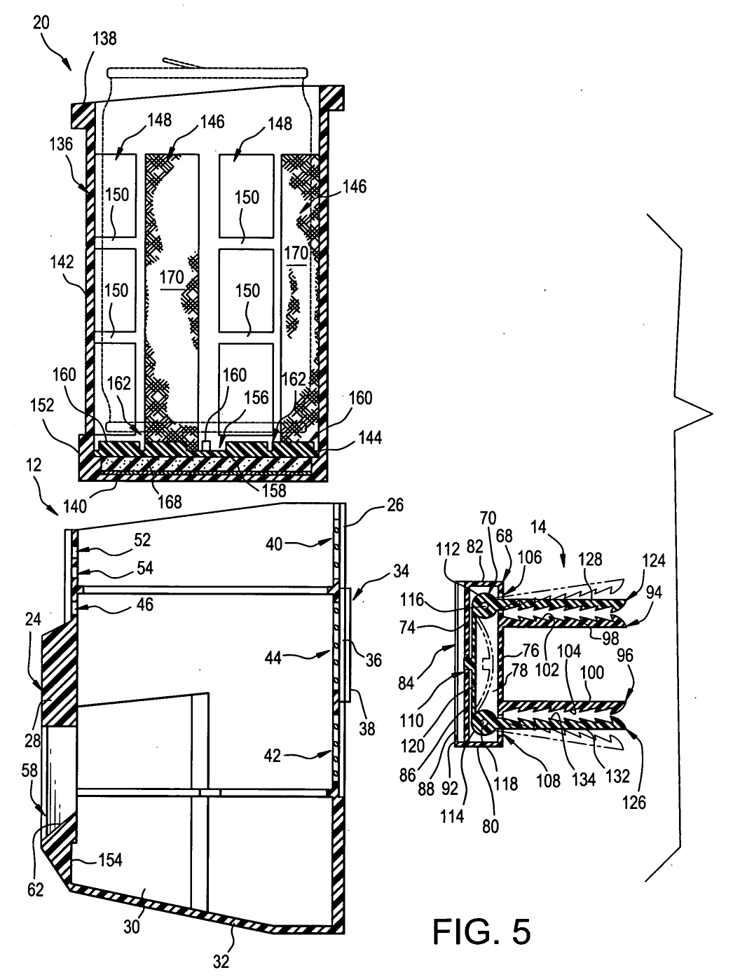

Base block 68 is provided with openings 106, 108, and 110 for access to the interior thereof. As illustrated in FIG. 5, opening 106 is positioned in back panel 76 above jaw 94. Opening 108 is positioned in back panel 76 below jaw 96. Finally, opening 110 is positioned in the center of front panel 74 between retaining flanges 84.

Resilient clip 70 includes a pair of rotatable wheels 112 and 114 each of which being positioned adjacent a respective one of openings 106 or 108. Each wheel 112 and 114 rotates upon an integral axle 116 and 118 that extends outwardly from the opposite sides thereof and is journaled in side panels 78 of block 68. A connecting arm 120, positioned closely adjacent front panel 74, connects wheels 112 and 114 together. An integral button 122 projects forwardly from the center of connecting arm 120 and into opening 110 in front panel 74. A pair of movable jaws 124 and 126 projects rearwardly from wheels 112 and 114.

Jaw 124 has a bar 128 that extends through opening 106 in back panel 76 and is affixed at its front end to wheel 112. The bottom of bar 128 is provided with a series of laterally spaced teeth 130 for gripping a flow diverter 72 of register 16. The positions of teeth 130 correspond with those of teeth 102 provided to jaw 94, the two being vertically offset.

Jaw 126 has a bar 132 that extends through opening 108 in back panel 76 and is affixed at its front end to wheel 114. The top of bar 132 is provided with a series of laterally spaced teeth 134 for gripping a flow diverter 72 of register 16. The positions of teeth 134 correspond with those of teeth 104.

Insert 20 includes a tubular sleeve 136 that releasably holds beverage container 22 and a peripheral collar 138 that extends outwardly from the top of sleeve 136 so as to rest upon the top of housing 12 and suspend sleeve 136 within housing 12. As shown, sleeve 136 includes a circular bottom wall 140 having a diameter that is slightly greater than that of container 22 and a cylindrical side wall 142 that is affixed to, and extends upwardly from, bottom wall 140. Side wall 142 is thickened somewhat adjacent bottom wall 140 so as to provide a peripheral shoulder 144 within sleeve 136.

Side wall 142 is provided with four vertical slots 146 and four vertical slots 148. Slots 146 are located at 90° intervals around side wall 142, and slots 148 are positioned between slots 146 in alternating fashion at 90° intervals. Both slots 146 and 148 extend from points immediately above shoulder 144 to points immediately below collar 138 and permit air to circulate into sleeve 136 through side wall 142. For reinforcement purposes, each of slots 148 is braced by a pair of spaced-apart spars 150 that extend horizontally from one side thereof to the other. A pin 152 extends outwardly from the front of side wall 142 that fits into a recess 154 in housing 12 so as to ensure proper alignment of insert 20 relative to housing 12.

A support plate 156 rests upon shoulder 144. Support plate 156 has a flat disk 158 with a diameter that is sufficiently small so as to permit the easy positioning thereof within sleeve 136 and is sufficiently large so as to engage shoulder 144 around its periphery. Radiating outwardly from the center of disk 158 at 45° intervals are eight upstanding ribs 160 that hold container 22 at a fixed height above disk 158. Each of ribs 160 is bifurcated by a notch 162 at the center thereof to promote the flow of air beneath container 22. Between alternate pairs of ribs 160, plate 156 is provided with a plurality of triangular or wedge-shaped cutouts 164 that permit air to circulate through plate 156. Cutouts 164 are bridged at their midpoints, located about half way from the center of disk 158 to its periphery, by reinforcing bars 166. Further, cutouts 164 are axially aligned with slots 146 in side wall 142.

An absorbent pad 168 of natural or artificial sponge is positioned in the bottom of sleeve 136. Sponge pad 168 is disk-shaped and is snugly fitted within the space that is bounded: at the bottom by bottom wall 140, at the top by support plate 156, and at the side by the thickened portion of side wall 142. During use of cooler 10, sponge pad 168 is saturated with water that is subsequently evaporated to impart a supplemental cooling effect to container 22 positioned within sleeve 136.

To optimize the cooling effect, a plurality of moisture wicking strips 170, formed of a mesh or webbing capable of drawing fluids along its length by capillary action, is placed in contact with sponge pad 168. Strips 170 extend upwardly from their points of contact with the bottom of pad 168, around support plate 156 at points adjacent cutouts 164, and upwardly into slots 146 in side wall 142 of sleeve 136. Strips 170 have a length and width sufficient to permit such to be adhered by any suitable means, like waterproof adhesives, to side wall 142 at the top, bottom, and sides of each slot 146.

The use of beverage cooler 10 is straightforward. First, mounting brackets 14 are detached from housing 12 by sliding base blocks 68 from mounting rails 34. Next, brackets 14 are engaged with register 16 by pressing jaws 94 and 124 and jaws 96 and 126 against fins or flow diverters 72 such that teeth 102, 104, 130, and 134 find a good grip. Now, rails 34 are slid into channels 90 in blocks 68 to mount housing 12 in a position adjacent register 16 to receive chilled air therefrom. Then, insert 20 is withdrawn from housing 12 and soaked in water for a few seconds so that absorbent pad 168 and wicking strips 170 can become saturated. Afterward, insert 20 is repositioned in housing 12 and an aluminum can or other beverage container 22 is set within sleeve 136 such that the container 22 comes to rest upon upstanding ribs 160. Once chilled air is caused to flow through housing 12, water will evaporate from wicking strips 170, lowering the temperature of strips 170 below that of the chilled air and causing container 22 to be similarly cooled. The water evaporated from strips 170 is replaced by means of capillary action, which causes water to be withdrawn from pad 168 as the water saturation of strips 170 is reduced. When the water is fully withdrawn from the pad 168 and strips 170, insert 20 can be recharged with a second soaking. Thus, beverage cooler 10 is always ready for immediate reuse.

While beverage cooler 10 has been described with a high degree of particularity, it will be appreciated by those skilled in the art that modifications can be made to it. For example, the number and location of inlets 40-50 and outlets 52-58 can be varied in accordance with design preferences. Therefore, it is to be understood that the present invention is not limited to beverage cooler 10 described above, but encompasses any and all beverage coolers within the scope of the following claims.

I claim:

1. A beverage cooler, comprising:
a housing having an inlet for receiving air from a register in a land vehicle and having an outlet in fluid communication with said inlet for discharging air into the passenger compartment of the land vehicle carrying the register;
a mounting bracket being connected to said housing for securing said housing to the register of a land vehicle;
an insert being removably positioned within said housing, said insert including:
a tubular sleeve being adapted to releasably hold a beverage container, said sleeve including:
a circular bottom wall; and,
a cylindrical side wall being affixed to, and extending upwardly from, said bottom wall, said side wall being provided with a longitudinal slot;
a peripheral collar extending outwardly from the top of said sleeve so as to rest upon the top of said housing;
an absorbent pad being positioned the bottom of said tubular sleeve atop said bottom wall; and,
a wicking strip for conveying, via capillary action, water away from said absorbent pad, said wicking strip being in contact with said absorbent pad and being secured within said slot in said side wall.

2. The beverage cooler according to claim 1 wherein said insert further includes a support plate positioned within said cylindrical side wall above said absorbent pad for bearing the weight of a beverage container positioned within said insert.
